(19) United States
(12) Patent Application Publication
(10) Pub. No.: US 2026/0084597 A1
(43) Pub. Date: Mar. 26, 2026

(54) SEAT BACK

(71) Applicant: TOYOTA BOSHOKU KABUSHIKI KAISHA, Aichi-ken (JP)

(72) Inventor: Satoru OHIRA, Toyota-shi (JP)

(73) Assignee: TOYOTA BOSHOKU KABUSHIKI KAISHA, Aichi-ken (JP)

(21) Appl. No.: 19/324,287

(22) Filed: Sep. 10, 2025

(30) Foreign Application Priority Data
Sep. 20, 2024 (JP) 2024-163534

(51) Int. Cl. B60N 2/58; B60N 2/66; B60N 2/68

(52) U.S. Cl. CPC B60N 2/5816; B60N 2/66; B60N 2/68

(57) ABSTRACT

A seat back comprises a frame, a lumbar support device, and a cushion member. The cushion member comprises a main member and a pair of side members. The main member has a main pad, a main cover, and a main support member. The lumbar support device is attached to the frame and is capable of locally adjusting the forward pressure in the vertical direction. The main support member is formed in a frame shape and has a lower opening. Curved portions are formed on a side opening frame. A convex portion of the main pad contacts the curved portion in the state of being passed through the slit formed at the edge of the main cover and restrains the curved portion from moving in the outward direction in the seat width direction.

### CROSS-REFERENCE TO RELATED APPLICATION

This application claims priority to Japanese patent application serial number 2024-163534, filed Sep. 20, 2024, the content of which is incorporated herein by reference in its entirety for all purposes.

### TECHNICAL FIELD

The present disclosure relates to a seat back. In particular, the present disclosure relates to a seat back in which a seat back member is divided into three parts in the seat width direction, consisting of a main member at a center and a pair of side members on both sides. This seat back facilitates easy assembly and replacement of deteriorated sections.

### BACKGROUND

There has been known a seat back for a vehicle seat in which a seat back member for elastically supporting the body of a seater is divided into three parts in the seat width direction and attached to a seat back frame. For example, a prior art discloses a seat back member having a seat back divided into a seat back main section at the center of the seat width direction and a seat back side sections located on both sides of the seat back main section. The seat back main section includes a main pad that is a cushion body. The main pad is covered with a main cover and attached to a main support member that supports the main pad in a planar manner. The vehicle seat having such a seat back is intended to be easy to assemble and to be compatible with automation of assembly, and to be easy to replace only the seat back side section, which is easily deteriorated when a seater gets in and out of the seat.

According to the seat back described in the above prior art, the seat back main section has the main support member which is in contact with a lumbar support device attached to the seat back frame. This causes the main pad to be pressed down through the main support member when the lumbar support device is activated. Therefore, although it is possible to press down on the lumbar position of the seater over a relatively wide area in a surface manner, it was difficult to press down locally. Therefore, in a seat back where the seat back member is divided into three sections in the seat width direction, there has been a desire to locally adjust the pressing pressure by the lumbar support device.

Therefore, there is a need to suppress the functional decline of the lumbar support device for the seat back in which the seat back member is divided into three sections in the seat width direction and assembled to the seat back frame.

### SUMMARY OF THE DISCLOSURES

According to one aspect of the present disclosure, a seat back has a frame for forming a framework, a lumbar support device attached to the frame, and a cushion member attached to the frame and elastically support a seater. The cushion member comprises a main member at the center portion in the seat width direction and a right-left pair of side members on both sides of the main member. The main member has a main pad or cushion body, a main cover to cover the main pad, and a main support member in an abbreviated plate-shape. The main support member attaches to a frame side of the main pad to support the main pad. The lumbar support device is capable of locally adjusting the forward pressure in the vertical direction and is located at the rear side of the main member. The main support member is formed in a frame shape with an opening, allowing the lumbar support device is able to contact directly the main pad at the rear surface for localized pressure adjustments. Curved portions formed on the outer peripheral portion in the seat width direction extend convexly toward the inner side of the seat width direction. The main pad has a number of projections on its rear surface that protrude rearward. These projections are positioned outside of the curved portions in the seat width direction where they contact the main support member. Slits are formed at the edge of the main cover in the seat width direction. The main cover is attached to the main support member by passing the curved portion of the main support member through the slit at the edge of the main cover. The projection contacts the curved portion in the state of being passed through the slit and restrains the curved portion from moving in the outward direction in the seat width direction.

The function of the lumbar support device is to provide adjustable support to the lumbar region of the seater. It is capable of locally adjusting the forward pressure in the vertical direction, allowing for different pressing forces to be applied to specific areas of the lumbar region. This helps in enhancing comfort and support for the seater's lower back. In addition, where the main cover is assembled to the main support member by passing the curved portion through the slit provided at the edge of the main cover in the seat width direction, the curved portion can be restrained from moving in the outward by projections on the main pad. This enables the main cover to be rigidly attached to the main support member, preventing functional deterioration of the lumbar support device.

### BRIEF DESCRIPTION OF DRAWINGS

FIG. 1 is a perspective view of an automobile seat to which a seat back of an embodiment is assembled.

FIG. 2 is an exploded perspective view of the seat back of FIG. 1.

FIG. 3 is a front view of the seat back of FIG. 1, wherein a side member is omitted.

FIG. 4 is a cross-sectional view taken along a line IV-IV in FIG. 3.

FIG. 5 is a cross-sectional view taken along a line V-V in FIG. 3.

FIG. 6 is a cross-sectional view taken along a line VI-VI in FIG. 3.

FIG. 7 is an exploded perspective view of a frame and a main member.

FIG. 8 shows an assembly procedure of the main member.

FIG. 9 shows an assembly procedure of the main member.

FIG. 10 shows an assembly procedure of the main member.

FIG. 11 shows an assembly procedure of the main member.

### DETAILED DESCRIPTION

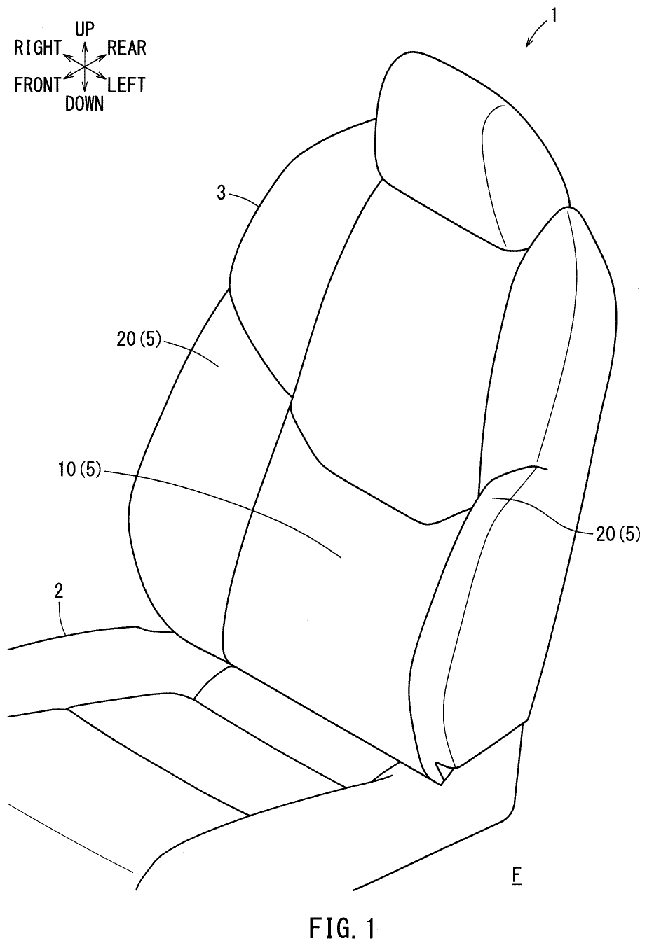

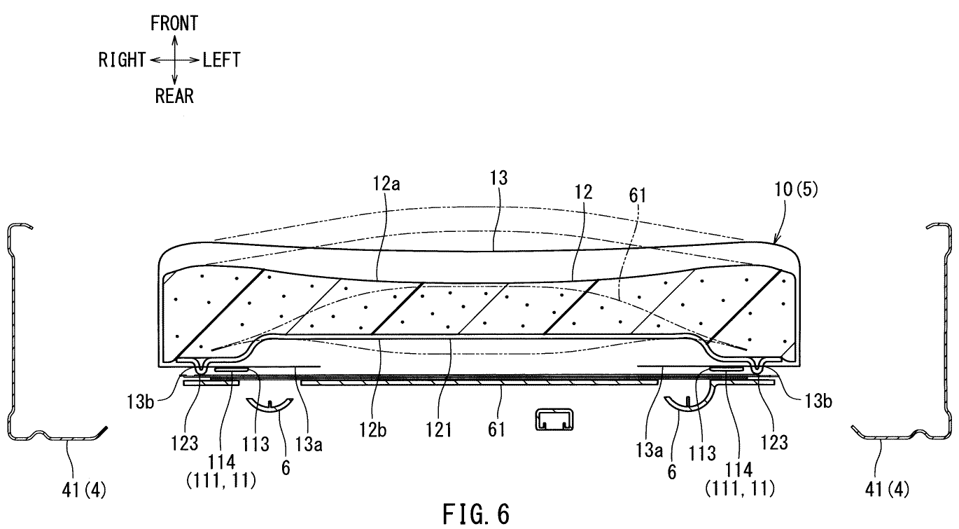

Referring to FIGS. 1 to 11, a seat back 3 of an automobile seat 1 in accordance with an embodiment of the present disclosure will be described. In the following description, explanations regarding the directions shall be based on the respective directions of up/down, front/rear, right/left as shown in each figure. Here, the up/down, front/rear, right/left directions are defined based on the automobile seat 1 when it is assembled on a floor F of the automobile. The right-left direction corresponds to the seat width direction.

As shown in FIG. 1, the automobile seat 1 has a seat cushion 2 supporting the buttocks and thighs of a seater and a seat back 3 supporting the waist and back of the seater.

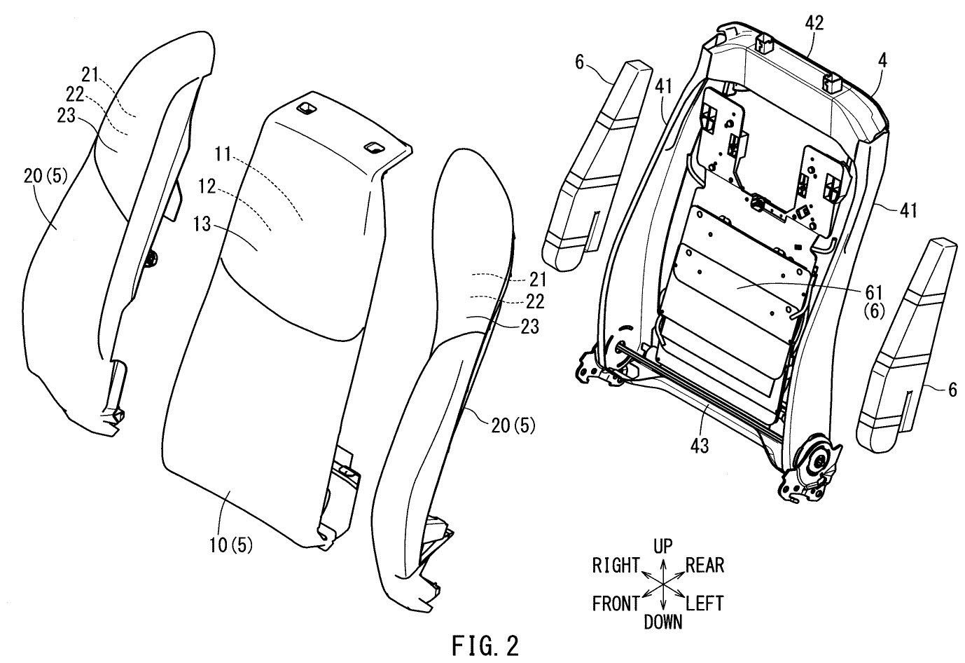

As shown in FIG. 2, the seat back 3 has a frame 4 that forms a framework, a cushion member 5 that has a cushioning function and defines the external shape of the seat back 3 attached on the frame 4, and a lumbar support device 6 attached on the frame 4.

As shown in FIG. 2, the frame 4 has a side frame 41, an upper frame 42, and a lower frame 43. The side frames 41 extends vertically in the right and left sides of the seat back 3. The upper frame 42 connects the upper end of each side frame 41. The lower frame 43 connects the lower end of each side frame 41. The frame 4 is formed in the shape of a rectangular frame viewed from the front. The lumbar support device 6 is located between the upper frame 42 and the lower frame 43 of the frame 4. The lumbar support device 6 has a plurality of bags 61 extending in the right-left direction arranged in a vertical line. As a result, it is possible to supply and exhaust air to each of the bags individually.

As shown in FIGS. 1 and 2, the cushion member 5 has a main member 10 at the center portion in the seat width direction and a right-left pair of side members 20 on both sides of the main member 10. The main member 10 is a portion that supports the waist and back of the seater from rear side. The side member 20 is a portion that supports the waist and back of the seater from the side.

The main member 10 has a main support member 11 made of resin and of an abbreviated plate shape, a main pad 12 that is a cushioning body positioned on the front side of the main support member 11 and supported against the frame 4 by the main support member 11, and a main cover 13 that covers the main pad 12 from the front side.

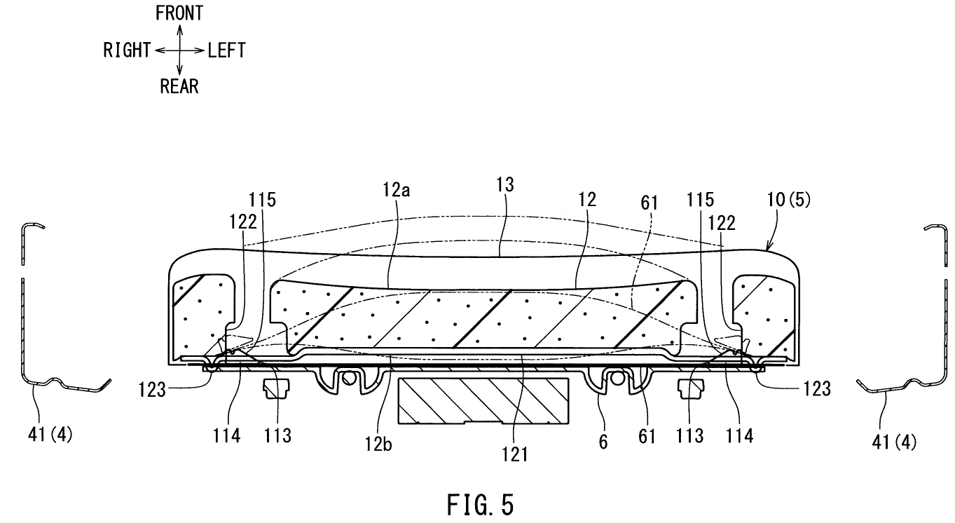

As shown in FIGS. 2 to 4, the main support member 11 has an upper part 11c, which is the upper half of the main support member 11, and a lower part 11d, which is the lower half of the main support member 11. The upper part 11c and lower part 11d are formed in the shape of a surface in contact with a rear surface 12b. The rear surface 12b is the opposite side of a front surface 12a. The front surface 12a is the seater's side of the main pad 12. The upper part 11c has an upper opening 11e at the center viewed from the front. The upper opening 11e is rectangular and penetrates the main support member 11 in the front-rear direction. The lower part 11d has a pair of side opening frames 111 extending downward from the lower right and left end of the upper part 11c, and a lower opening frame 112 connecting the lower ends of the respective side opening frames 111. The lower opening 113 is an area bounded by the lower end of the upper part 11c, each side opening frames 111, and the lower opening frame 112. The lower opening 113 penetrates the main support member 11 in the front-rear direction. The lower opening 113 is larger than the upper opening 11e. A right-left pair of curved portions 114 are arranged vertically side by side on each side opening frames 111. The curved portions 114 are curved and project inward in the seat width direction. Each of the curved portions 114 is formed in a C-shape having an opening on the outside of the seat width direction when viewed from the front. Three ribs 115 extending in a right-left direction are disposed on each of the curved portions 114 toward the front. In detail, as shown in FIG. 5, the ribs 115 have a mountain shape with the center of the right-left direction projecting forward when viewed from above. The three ribs 115 extend in a parallel right-left direction when viewed from the front. The vertical distance between the uppermost rib 115 and the lowermost rib 115 is set approximately equal to the vertical length of a convex portion 123. Notches 116 are formed at the upper and lower ends of each curved portion 114 on the inner side of each side opening frame 111 in the seat width direction. The notches 116 allow each of the curved portion 114 to be easily torsionally deformed in the front-back direction. The rear surface of the upper part 11c of the main support member 11 is fixed to the upper frame 42. The rear surface at approximately the center in the vertical direction of the lower part 11d is fixed to the lumbar support device 6. Here, the side opening frame 111 corresponds to the “outer peripheral portion” of the present disclosure. The lower opening 113 corresponds to the “opening” of the present disclosure.

As shown in FIGS. 2 to 7, the main pad 12 is an elastic body made of a foam molded body of polyurethane resin. The main pad 12 has approximately the same external shape as the main support member 11 when viewed from the front. A felt 121 is integrally molded into the rear surface 12b of the main pad 12. As shown in FIG. 5, the felt 121 serves to form an air supply path 122 for air supplied from an air conditioning device (not shown) disposed in the seat back 3. The convex portion 123 extending in the vertical direction is formed at the rear side of the felt 121, which constitutes a part of the rear surface 12b of the main pad 12. The convex portion 123 abuts on the outer side of the seat width direction of each curved portion 114 in a state where the front surface of the main support member 11 is in contact with the rear surface 12b of the main pad 12. The height of the convex portion 123 in the front-rear direction is set to be about three times the thickness of the curved portion 114. The length of the convex portion 123 in the vertical direction is set to about ½ the length of the curved portion 114 in the vertical direction. The convex portion 123 contacts the outside of the curved portion 114 of the main support member 11 in the seat width direction when the main member 10 is formed. Therefore, the curved portion 114 is prevented from moving toward the outside of the seat width direction. Here, the convex portion 123 corresponds to the “projection” of the present disclosure.

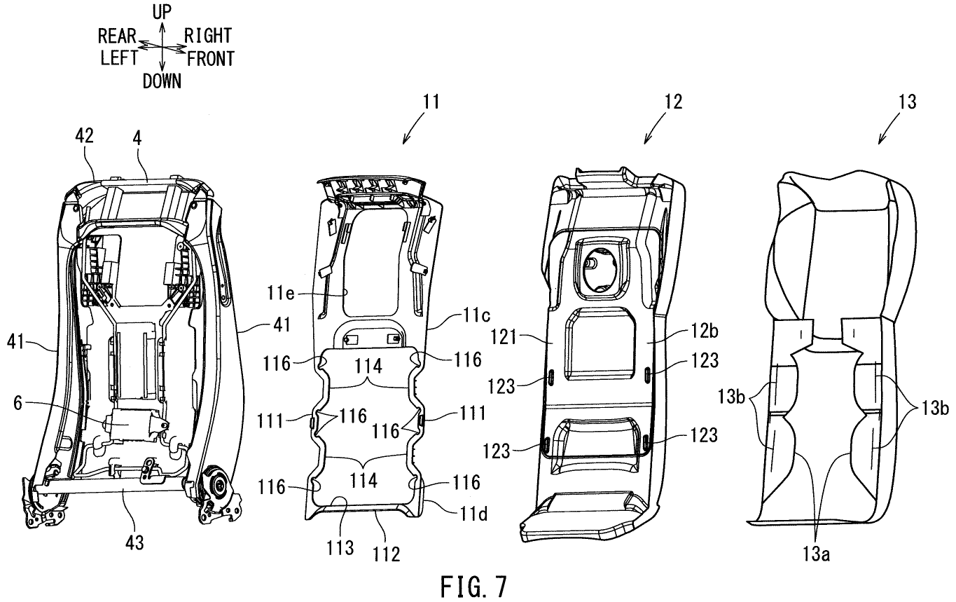

As shown in FIGS. 2 to 7, the main cover 13 is formed by sewing multiple pieces laminated with a thin urethane slab pad on fabric together. The main cover 13 is a bag-shaped cover member that opens rearwardly. The main cover 13 is covered from the front surface 12a against the main pad 12 arranged on the front side of the main support member 11. The end portion of the opening of the main cover 13 is then fastened to the side opening frame 111 of the main support member 11, thereby the main member 10 is formed. As shown in FIG. 7, slits 13b extending in the vertical direction are formed in the main cover 13 at positions corresponding to the respective curved portions 114 of the main support member 11 in the right and left ends 13a. With the main support member 11 in contact with the rear surface 12b of the main pad 12, the main cover 13 is placed over the main pad 12 from the front surface 12a side. Then, each curved portion 114 is passed through each slit 13b while wrapping the end 13a around the rear side 12b of the main pad 12, thereby the main member 10 is formed. The curved portion 114 has three ribs 115 extending in a right-left direction to increase rigidity. Therefore, it is easy to pass the curved portion 114 through the slit 13b.

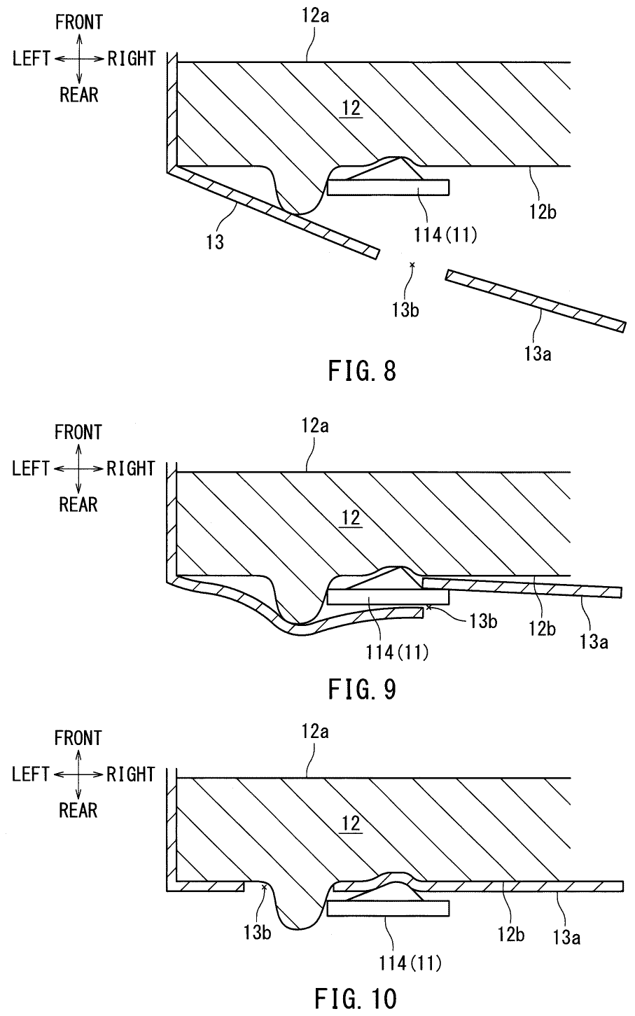

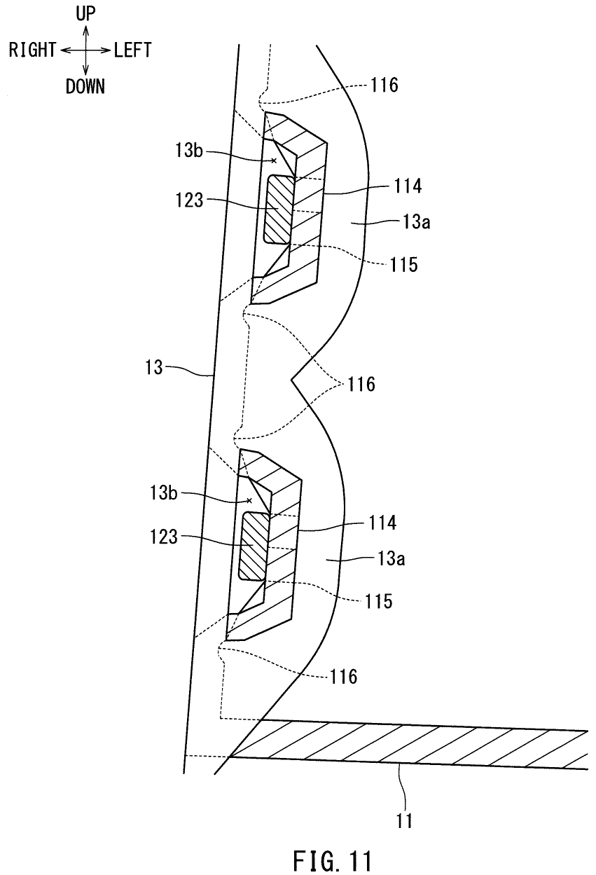

Referring to FIGS. 8 to 11, the assembly procedure of the main member 10 will be explained. First, as shown in FIG. 8, with the front surface of the main support member 11 in contact with the rear surface 12b of the main pad 12, the main cover 13 is placed over the front surface 12a of the main pad 12. Then, as shown in FIG. 9, each curved portion 114 is passed through each slit 13b while wrapping the end 13a of the main cover 13 around the rear surface 12b of the main pad 12. Then, as shown in FIG. 10, each of the curved portions 114 protruding from each slit 13b comes out the rear side of the end 13a and presses the end 13a against the rear side 12b of the main pad 12 via the three ribs 115. As shown in FIG. 11, the top and bottom ends of each curved section 114 engage the top and bottom ends of each slit 13b. Each rib 115 presses down on each end 13a. Thereby, the main cover 13 is maintained in a state in which it covers the main pad 12. At this time, each convex portion 123 of the main pad 12 contacts the outside of each curved portion 114 of the main support member 11 in the seat width direction, thereby preventing each curved portion 114 from moving toward the outside of the seat width direction.

As shown in FIG. 2, the side member 20 has a side support member 21, a side pad 22, and a side cover 23. The side support member 21 is made of, for example, resin. The side pad 22 is a cushioning body arranged at the front side of the support member 21. The side pad 22 is supported against the frame 4 by the side support member 21. The side cover 23 covers the side pad 22 from the front side. The side support member 21 is, for example, an abbreviated plate-shaped member made of resin. The side pad 22 is an elastic body made of a foam molded body of polyurethane resin similar to the main pad 12. The side pad 22 has approximately the same external shape as the side support member 21 when viewed from the front. Similar to main cover 13, the side cover 23 is formed by sewing multiple pieces laminated with a thin urethane slab pad on a fabric together. The side cover 23 is a bag-shaped cover member that opens rearwardly. The side cover 23 is covered from the front side against the side pad 22 arranged on the front side of the side support member 21. Then, the end portion of the opening of the side cover 23 is fastened to the rear side of the outer edge of the side support member 21, thereby the side member 20 is formed.

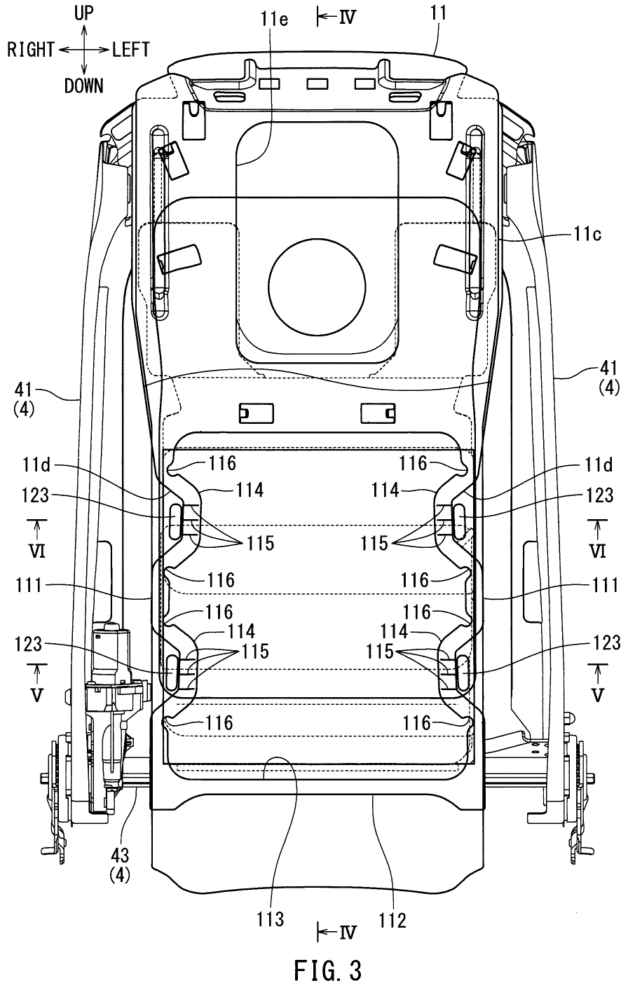

The assembly procedure of the seat back 3 will be described. First, as shown in FIGS. 3 to 5, the lumbar support device 6 is arranged between each of the side frames 41 of the frame 4, so as to bridge the upper frame 42 and lower frame 43. The right and left side members 20, which are pre-assembled, are then attached to the frame 4 by fixing the side support members 21 in place with screws. Next, the main member 10, which is pre-assembled, is attached to the frame 4 by fixing the upper part 11c of the main support member 11 to the upper frame 42 and fixing approximately the center portion in the vertical direction the lower part 11d to the rear surface of the lower frame 43. Thereby, each bag 61 of the lumbar support device 6 is positioned with a part of the right and left ends overlapping the rear side of each curved portion 114 of the main support member 11, and most of the center portion is positioned in direct contact with the rear surface 12b of the main pad 12.

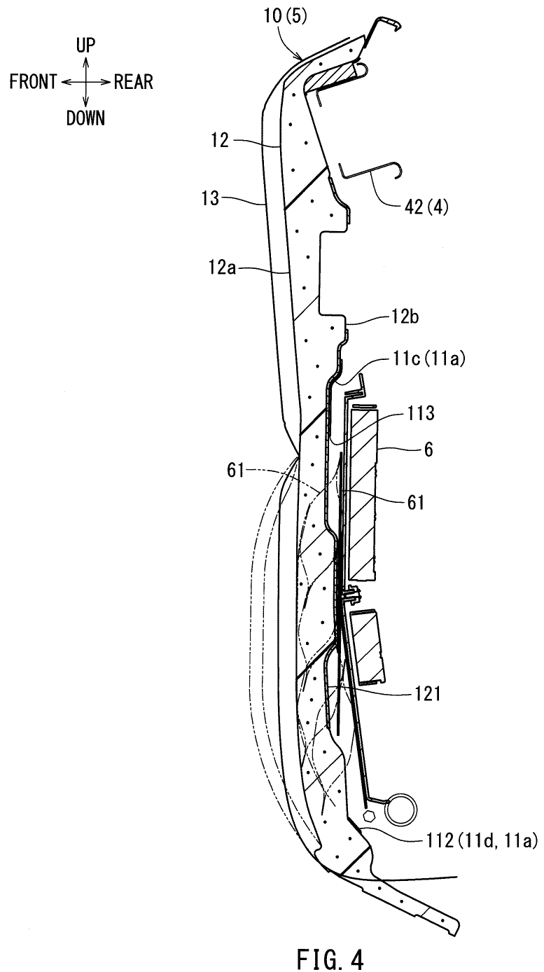

As shown in FIGS. 4 to 6, the seat back 3 assembled as described above expands as shown in the double-dotted line by supplying air to each bag 61 when the lumbar support device 6 is activated. Accordingly, the main pad 12 and the main cover 13 also expand as shown in the double-dotted line. The air supplied to each bag 61 can be adjusted independently. Therefore, certain areas of the rear surface 12b of the main pad 12 in the vertical direction can be pressed more strongly than other areas. In addition, since most of the center of each bag 61 is arranged in direct contact with the rear surface 12b of the main pad 12, it is possible to provide a localized pressing force in the vertical direction on the lower back of the seater. Furthermore, a portion of the left-right end in each bag 61 is arranged to overlap each curved portion 114 of the main support member 11. Each curved portion 114 is easily torsionally deformed in the front-rear direction. As a result, it is possible to press down on the waist of the seater in a wider area in the seat width direction.

The embodiment described above has the following effects. The main support member 11 is formed in a frame shape having a lower opening 113. Therefore, the lumbar support device 6 can directly contact with the rear surface 12b of the main pad 12. The lumbar support device 6 can adjust the forward pressure by independently adjusting the air supplied to each of the bags 61 locally in the vertical direction. This allows the lumbar support device 6 to directly press down on the main pad 12 to apply different pressing forces locally in the vertical direction to the lumbar region of the seater. The curved portion 114 of the main support member 11 is passed through the slit 13b at the end 13a of the main cover 13. The convex portion 123 contacts the curved portion 114 in a state where the main cover 13 is fastened to the main support member 11. Therefore, the movement of the curved portion 114 in the outward direction of the seat width direction can be restrained. This enables the main member 10 to be in a state where the main cover 13 is firmly attached to the main support member 11 while preventing functional deterioration of the lumbar support device 6.

The curved portion 114 is configured to be torsionally deformed in the front-rear direction by pressure when the lumbar support device 6 is activated. Even if the curved portion 114 is arranged overlapping a part of the lumbar support device 6, the curved portion 114 can be torsionally deformed in the front-rear direction by pressure from rear when the lumbar support device 6 is activated. Therefore, the area where the lumbar support device 6 presses in the seat width direction can be widened.

Furthermore, notches 116 are formed at the upper and lower ends of the curved portion 114 on the inner side of the side opening frame 111. The notches 116 are a weakening portion that facilitate twisting and deformation of the curved portion 114 in the front-rear direction. The notches 116 allow the curved portion 114 to be more easily torsionally deformed by pressure from rear when the lumbar support device 6 is activated.

Additionally, three ribs 115 extending in the seat width direction are disposed on the front side of the curved portion 114 to maintain the rigidity of the curved portion 114, making it easier to pass the curved portion 114 through the slit 13b of the main cover 13 when assembling the main member 10.

According to another aspect, the curved portion is configured to be torsionally deformed in the front-rear direction by pressure when the lumbar support device is activated.

Therefore, even if the curved portion is arranged overlapping a part of the lumbar support device, it is torsionally deformed in the front-rear direction by being pressed from rear when the lumbar support device is activated. Thus, the area where the lumbar support device presses in the seat width direction can be widened.

According to another aspect, notches are formed in the upper and lower ends of the curved portion in the outer peripheral portion as a weakening portion to facilitate twisting and deformation of the curved portion.

Therefore, when the lumbar support device is activated, the curved portion can be more easily torsionally deformed by pressure from the rear.

According to another aspect, a rib extending in the seat width direction is disposed on the front side of the curved portion.

Therefore, the rigidity of the curved portion is maintained, which makes it easier to pass the curved portion through the slit in the main cover when assembling the main member.

Although certain embodiments have been described above, the present disclosure is not limited to their appearance and configuration, and various changes, additions, and deletions are possible to the extent that the gist of the present disclosure is not changed. For example, the following are examples.
1. According to the above embodiment, the lumbar support device 6 has multiple bags 61 extending in the right-left direction arranged in a vertical line that each bag 61 can be supplied and discharged individually. However, it may be a mechanical device that can adjust the movement of band-shaped plate members arranged vertically in the front-rear direction individually.
2. According to the above embodiment, the seat back 3 is applied to the automobile seat 1, but it can also be applied to seats of airplanes, railroad vehicles or ships.

The various examples described above in detail with reference to the attached drawings are intended to be representative of the present disclosure and are thus non-limiting embodiments. The detailed description is intended to teach a person of skill in the art to make, use and/or practice various aspects of the present teachings, and thus does not limit the scope of the disclosure in any manner. Furthermore, each of the additional features and teachings disclosed above may be applied and/or used separately or with other features and teachings in any combination thereof, to provide an improved seat back and/or methods of making and using the same.

We claim:

1. A seat back comprising:
a frame configured to form a framework;
a lumbar support device attachable to the frame;
a cushion member attachable to the frame for elastically supporting a seater,
wherein the cushion member comprises a main member positioned at the center portion in a seat width direction and a pair of side members on both sides of the main member,
wherein the main member comprises a main pad, a main cover configured to cover the main pad, and a main support member configured to support the main pad,
wherein:
a plurality of curved portions, extending convexly toward the inner side of the seat width direction, are formed on the main support member;
a plurality of projections are formed on the rear surface of the main pad, wherein the plurality of projections protrudes rearward, and wherein the plurality of projections is positioned outside of the curved portions in the seat width direction in a state where the projections are in contact with the main support member; and
a plurality of slits are formed at an edge of the main cover in the seat width direction, wherein the main cover is attachable to the main support member.

2. The seat back according to claim 1, wherein the curved portion is configured to be torsionally deformed in the front-rear direction by pressure when the lumbar support device is activated.

3. The seat back according to claim 2, wherein notches are formed in the upper and lower ends of the curved portion in the outer peripheral portion as a weakening portion to facilitate twisting and deformation of the curved portion.

4. The seat back according to claims 1, wherein a rib extending in the seat width direction is disposed on the front side of the curved portion.

5. The seat back according to claim 1, wherein the plurality of curved portions is formed on the outer peripheral portion in the seat width direction.

6. The seat back according to claim 1, wherein the lumbar support device is configured to adjust the forward pressure locally in a vertical direction and located at the rear side of the main member.

7. The seat back according to claim 1, wherein the main support member is configured to contact the lumbar support device directly with the rear surface of the main pad and formed in a frame shape with an opening.

8. An assembly method of a main member of a seat back, the method comprising:
positioning a main support member by placing a front surface of the main support member in contact with a rear surface of a main pad;
covering the main pad by placing a main cover over a front surface of the main pad;
passing a plurality of curved portions of the main support member through a plurality of slits by wrapping ends of the main cover around the rear surface of the main pad;
securing the main cover by ensuring the curved portions to protrude from the slits and pressing the ends of the main cover against the rear side of the main pad via a plurality of ribs on the plurality of curved portions, wherein top and bottom ends of each of the plurality of curved portion engage with top and bottom ends of each of the plurality of slit to secure the main cover in place.

9. The method of claim 8, wherein the main cover is a bag-shaped cover member that opens rearwardly.
